(19) United States
(12) Patent Application Publication
(10) Pub. No.: US 2026/0280729 A1
(43) Pub. Date: Sep. 17, 2026

(54) NETWORK NODE AND METHOD FOR SPLIT ANTENNA PANELS CALIBRATION

(71) Applicant: Telefonaktiebolaget LM Ericsson (publ), Stockholm (SE)

(72) Inventors: Magnus NILSSON, Lund (SE); Torsten CARLSSON, Lund (SE); Peter ALMERS, Limhamn (SE); Christian BRAUN, Vallentuna (SE); Ang FENG, Solna (SE)

(21) Appl. No.: 19/469,718

(22) PCT Filed: Mar. 31, 2023
(86) PCT No.: PCT/SE2023/050290

§ 371 Date: Sep. 26, 2025

(51) Int. Cl. H04B 17/12; H04B 17/21; H04B 17/309

(52) U.S. Cl. CPC H04B 17/12; H04B 17/221; H04B 17/309

(57) ABSTRACT

A network node (210) and method therein for antenna calibration in a wireless communication system (200) are provided. The network node (210) comprises two or more antenna panels which are separated and isolated from each other. At least one antenna panel (411) comprises both transmitting and receiving (TX/RX 411) antenna arrays, and at least one antenna panel (412) comprises only receiving (RX 412) antenna array. The TX/RX antenna arrays are pre-calibrated and one or more spatial-temporal channel parameters are estimated for the TX/RX antenna arrays based on estimated channel-state information for a propagation channel between a user equipment and the TX/RX antenna arrays using a signal received from the user equipment via the TX/RX antenna arrays. Then the RX antenna array is calibrated based on the one or more spatial-temporal channel parameters and estimated channel-state information for the RX antenna array on a propagation channel between the user equipment and the RX antenna array using a signal received via the RX antenna array.

### TECHNICAL FIELD

Embodiments herein relate to antenna calibration. In particular, they relate to a network node and method therein for split antenna panels calibration in a wireless communication system.

### BACKGROUND

A radio unit in a wireless communication system usually comprises transceivers (TRX) which comprise receivers for receiving (RX) signals and transmitters for transmitting (TX) signals. The transmitters typically up-convert baseband signals to Radio Frequency (RF) signals for transmission, and the receivers down-convert received RF signals to baseband signals for processing. The transceivers usually use antenna unit or system comprising multiple antennas or antenna arrays to transmit and receive RF signals. The antenna unit is one of the most crucial components in the radio unit. Today's complex antenna systems involving operating at multiple frequencies as well as multiple standards on the same radio unit, put great demands on the ability to create effective antenna solutions.

In general, duplex in a wireless communication system is a point-to-point system composed of two or more connected parties or devices that can communicate in both directions. For example, a base station (BS) and a mobile device, e.g. User Equipment (UE), communicate in both directions, i.e. uplink (UL) from the mobile device to the base station, and downlink (DL) from the base station to the mobile device. In today's communication system, the duplexing is accomplished by splitting the UL and DL resources in either time, i.e. Time-Division-Duplex (TDD), or frequency, i.e. Frequency-Division-Duplex (FDD) or both.

Besides TDD and FDD modes, full-duplex also attracts a lot of attentions in recent years, especially in the 6^{th} Generation (6G) communication system research.

In-band full-duplex (IBFD) is here referred to communications in both UL and DL at the same channel resources, i.e., at the same time and frequency and this is made possible by cancelling the known transmitted signal interfering with the receiver. In practice this is very challenging due to the extreme signal strength of the transmitted signal leaking into the receiver chain compared to the UL signal itself.

A cellular communication system is normally imbalanced in that the BS has much higher total output power than the UE. Thus, the coverage of DL is better than the coverage of UL. To compensate such imbalance, it is beneficial to allocate more slots to UL. However, the throughput of DL may be impacted. A more promising solution is by employing full-duplex, in which UL and DL can be better balanced. Due to technical challenges to achieve full duplex, sub-band full-duplex (SBFD) and/or full duplex in only a few slots can be arranged.

SBFD is here referred to a relaxed solution where an UL frequency carrier is placed in-between two combined DL carriers. There is still signal leaking into the receiver chain but less due to the separation of DL and UL frequency portions inside the carrier frequency. Leakage suppression is further accomplished by a design using a separate and isolated antenna array with receiver functionality only in the UL band.

Integration of communication and radar systems has emerged in the 6G communication system research. Historically, these two systems are designed and optimized independently. As technology evolves, adding radar capabilities into the communication system can be seen as a nature result. The resulting approach, as known as joint communication and sensing (JCAS), has many benefits. For example, with empowerment of JCAS, it is possible to utilize the communication network to detect such as an obstacle in front of a BS, an accidence in a traffic, or falling down of elder people, and so forth. A basic requirement of JCAS is, TX antennas and RX antennas have to work simultaneously so that RX antennas can receive the signals transmitted from TX antennas that are reflected at objects. To realize this, split and isolated antenna panels or arrays are also indispensable. In the following, the terms “antenna panels” and “antenna arrays” may be used interchangeably.

In the latest development of antenna technology there has been much attention to split multi-panel antenna arrangements, as shown in FIG. 1. FIG. 1 shows two example settings (a) and (b) with split antenna panels of full-duplex in a BS. In setting (a), two antenna panels with full TX and RX functionalities are implemented. In setting (b), one of the antenna panels is with both TX/RX functionalities and the other is only RX functionality. In setting (a), two antenna panels can be configured to TX+TX for DL, TX+RX for SBFD, and RX+RX for UL. In setting (b), an RX only antenna panel is used instead of having two TX/RX antenna panels. There are both cost and performance benefits in setting (b). Cost is lower since there is no transmitting hardware required in the RX only antenna panel, and in addition, cooling needs are also significantly relaxed.

Performance may be significantly better in an RX only antenna panel, compared to an TX/RX antenna panel. Antenna elements in the RX only antenna panel can be separated since there is no TX requirements, like grating lobes or scan blindness. Loss is reduced since circulator and TDD switch are removed. Filter can be optimized for RX only requirements. All together sensitivity for the same number of antenna ports can be in the range 1-2 dB better in Frequency Range 1 (FR1) and 2-3 dB better in FR2 if using an RX only antenna panel.

By comparing settings (a) and (b), it is seen that although setting (a) has more flexibility but setting (b) has better performance in different duplex modes e.g. in SBFD applications, and has capabilities in such as UL sensitivity boosting, DL leakage suppression etc. For these reasons, setting (b) is more preferred than setting (a) in the industry.

For a simple building practice, and also for achieving high isolation between antenna panels, the multiple antenna panels are usually displaced so that there is a physical distance between the edges of the antenna panels. This distance can be several wavelengths, even if the antenna panels are mounted on the same radio unit.

There are many advantages having a split multi-panel antenna arrangement, for example, improved UL or RX sensitivity, creating favourable isolation conditions between TX part and RX part of the antenna array for use-cases as in-band or sub-band full-duplex. Further, the split multi-panel antenna arrangement may benefit JCAS and pulsed radar applications. For a pulsed radar system, the transmit pulse will interfere or leak into the RX chain for the duration of the pulse, hence if the delay of the received pulse, which is proportional to the distance, to a reflecting object is shorter than the length of the pulse, the TX pulse will interfere with the RX pulse. This TX pulse leakage into the received signal can be reduced by such a split multi-panel antenna arrangement.

In advanced antenna system (AAS), beamforming is utilized both to improve coverage and capacity of a base station. Since the wavelength is small at high frequency, e.g. at FR2 which is 24.25-52.6 GHz, multiple antennas or antenna arrays with hundreds or even thousands of antenna elements are feasible.

Beamforming is enabled by transmitting or receiving signals with controlled relative phase and gain in the antenna elements. The antenna element signals can either add or subtract coherently in desired directions. Several UEs can be addressed simultaneously by forming multiple beams.

Accurate beamforming requires precise control of the relative phase and gain in between the antenna elements. When implementing an AAS radio unit, a lot of impairments adds to uncertainty in relative phase and gain between the antenna elements. Some impairments origin from production variations, other from thermal and supply variations. In order to detect and compensate these variations, antenna calibration (AC) is used. AC is a typical method to estimate and compensate the impairments of above-mentioned imperfections. To achieve accurate beamforming, the multiple antennas must be continuously calibrated while the radio unit is in use to enable a dynamic compensation.

To take full advantages of the multi-panel antenna arrangement it is needed that both panels are well calibrated, so that the two panels can receive signals that by means of beamforming can amplify the signal from a UE from a particular direction.

There are two AC solutions commonly used in BS, one is called radio distribution network (RDN) based AC, and another one is called mutual coupling (MC) based AC. In the RDN AC, a RDN board is inserted between RF chains and antennas with a coupler network to transmit and receive the AC signal. It needs extra hardware, so the cost is increased. In the MC AC, e.g. as disclosed in WO2020/043310, the calibration loop of AC is established by mutual coupling between antennas in the panel arranged to TX and RX mode. MC AC needs a high and stable coupling level between antennas in the panel to make sure the received signal quality is good enough for estimating of phase errors.

There is a problem to achieve antenna calibration in a cost-efficient manner for split antenna panels. The TX/RX antenna panel can be efficiently calibrated using MC AC. However, the RX only panel cannot be calibrated using MC AC, because this method requires the antenna panel to be both TX and RX capable. It is also impossible to use TX/RX panel to calibrate RX only panel because they have very high isolation meaning very low mutual coupling in between.

Alternatively, the RX only panel may be calibrated by using a dedicated hardware coupler network. This increases cost and restricts building practice, thus not considered as an attractive product solution.

Alternatively, the RX only panel may be calibrated by in-field antenna calibration (in-field AC). With this method it is possible to calibrate the RX only panel by using UE's reference signals and UL channel estimates. It however comes with one important limitation in that it cannot resolve a fully uncalibrated RX panel, because it requires an initial calibration, although to a relaxed accuracy, to be able to function. It is difficult to achieve this initial calibration for the RX only panel without hardware implications.

In short, there is a need for calibration of split antenna panels to empower a beamforming on either TX/RX panel or RX only panel, but so far there is no good solution exists.

### SUMMARY

It is therefore an object of embodiments herein to provide an improved method for antenna calibration in a wireless communication system.

According to one aspect of embodiments herein, the object is achieved by a network node and method therein for antenna calibration in a wireless communication system. The network node comprises two or more antenna panels which are separated and isolated from each other. At least one antenna panel comprises both transmitting and receiving (TX/RX) antenna arrays, and at least one antenna panel comprises only receiving (RX) antenna array. The TX/RX antenna arrays are pre-calibrated using any known AC calibration method, e.g. MC AC.

The network node is configured to receive a signal sent from a user equipment via both the TX/RX antenna arrays and RX antenna array. The signal sent from the user equipment may be a Sounding Reference Signal (SRS), a Physical Random Access Channel (PRACH) signal, a UE specific reference signal e.g. DeModulation Reference Signal (DMRS), or a UE's UL data signal.

The network node is further configured to estimate channel-state information (CSI) for the TX/RX antenna arrays on a propagation channel between the user equipment and the TX/RX antenna arrays based on the received signal.

The network node is further configured to estimate one or more spatial-temporal channel parameters based on the estimated CSI for the TX/RX antenna arrays. The one or more spatial-temporal channel parameters may be any one or more of direction-of-arrival (DoA), time-of-arrival (ToA), Doppler spread, delay spread, angular spread etc.

The network node is further configured to estimate CSI for the RX antenna array on a propagation channel between the user equipment and the RX antenna array based on the received signal.

The network node is further configured to estimate antenna calibration errors for the RX antenna array based on the estimated CSI for the RX antenna array and the one or more estimated spatial-temporal channel parameters for the TX/RX antenna arrays.

The network node is further configured to calibrate the RX antenna array based on the estimated antenna calibration errors.

According to some embodiments herein, the network node is further configured to periodically perform the calibration on the TX/RX antenna arrays using MC AC and the calibration on the RX antenna array according to the method described above.

According to some embodiments herein, a computer program product comprising program code which when the program is executed by a computer, cause the computer to carry out the method described above for antenna calibration.

In other words, embodiments herein provide a network node, e.g. a BS, and method therein for antenna calibration of two or more split antenna panels comprised in the network node, at least one is a TX/RX antenna panel comprising both TX and RX antenna arrays, at least one is RX only panel comprising only RX antenna array. The antenna calibration method is valid for a realistic scenario where both TX/RX antenna panel and RX only antenna panel are both uncalibrated.

The antenna calibration method provided herein can calibrate the RX antenna array, with channel parameters provided from the pre-calibrated TX/RX antenna arrays.

The TX/RX antenna arrays may be pre-calibrated using any known AC method e.g. MC AC. Then CSI is estimated for the pre-calibrated TX/RX antenna arrays by using a received signal from a UE to derive relevant spatial-temporal channel parameters, e.g. DoA or ToA. The relevant spatial-temporal channel parameters are provided to the RX antenna array and used for calibration of the RX antenna array.

The antenna calibration error for the RX antenna array is estimated by using a received signal via the RX antenna array together with the relevant spatial-temporal channel parameters obtained from the pre-calibrated TX/RX antenna arrays. Then the RX antenna array is calibrated based on the estimated antenna calibration error.

The antenna calibration method according to embodiments herein provides some advantages such as:

Embodiments herein provide a cost-efficient solution to calibrate a split antenna panels for a network node deployed with TX/RX antennal panel and RX only antenna panel with high isolation between the TX/RX and RX antenna panels, thereby enabling beamforming in a full-duplex radio unit. No extra coupler network or other calibration-specific hardware is needed for calibration of the RX only antenna panel. As a result, the size and weight of the full-duplex radio unit is reduced.

Embodiments herein are applicable to a totally uncalibrated antenna panel. No need for pre-calibration for a RX only antenna panel.

Embodiments herein are applicable to applications such as UL sensitivity boost, Joint communication and sensing (JCAS) or pulsed radar, full-duplex, such as in-band full-duplex and sub-band full-duplex radio units and provide some benefits to these applications.

The calibration on the TX/RX and RX antenna panels may be performed periodically to track phase drifts over the time.

Therefore, embodiments herein provide an improved network node and method therein for antenna calibration in a wireless communication system.

### BRIEF DESCRIPTION OF THE DRAWINGS

Examples of embodiments herein are described in more detail with reference to the attached drawings in which:

FIG. 1 is a schematic block diagram illustrating examples of multi-panel antenna arrangements;

FIG. 2 is a schematic block diagram illustrating a wireless communication system;

FIG. 3 is a flow chart illustrating a method for antenna calibration according to embodiments herein; and

FIG. 4 is a block diagram illustrating a network node in which a method for antenna calibration according to embodiments herein may be implemented.

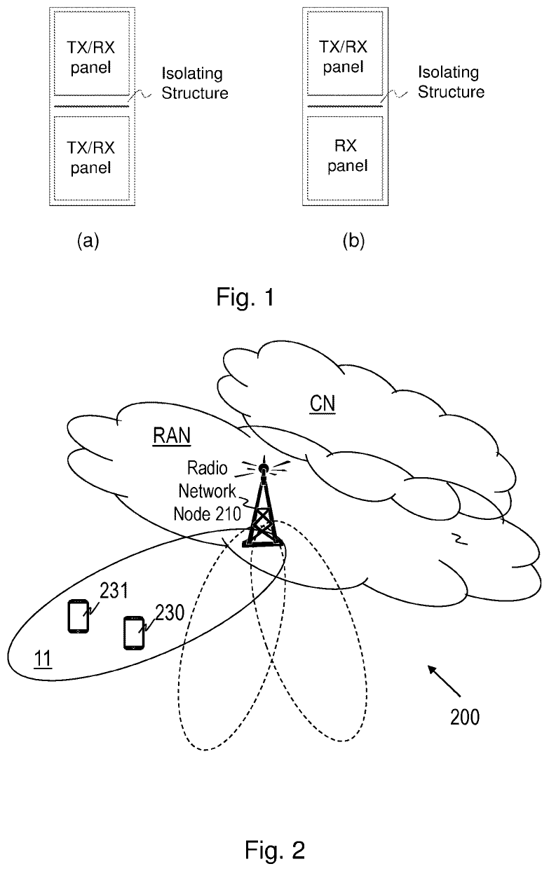

### DETAILED DESCRIPTION

Embodiments herein relate to a communications system in general. FIG. 2 is a schematic overview depicting a communication system 200. In a typical wireless communication system, wireless devices, also known as wireless communication devices, mobile stations, and/or user equipment (UE), communicate via a Radio Access Network (RAN) to one or more core networks (CN). The RAN covers a geographical area which is divided into service areas or cell areas, which may also be referred to as a beam or a beam group, with each service area or cell area being served by a radio network node. A service area or cell area is a geographical area where radio coverage is provided by the radio network node. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU). Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

The communication system 200 may comprise one or more RANs. The communication system 200 may use a number of different technologies such as Global System for Mobile communications/Enhanced Data rate for GSM Evolution (GSM/EDGE), Wideband Code Division Multiple Access (WCDMA), Worldwide Interoperability for Microwave Access (WiMax), Ultra Mobile Broadband (UMB), Wi-Fi, Long Term Evolution (LTE), LTE-Advanced, New Radio (NR) etc., just to mention a few possible implementations.

In the wireless communication system 200, one or more wireless communication devices 230, 231 such as a UE, a mobile station or a wireless terminal communicates via one or more RANs to one or more CNs. It should be understood by the skilled in the art that “wireless communication device” is a non-limiting term which means any terminal, wireless communication terminal, user equipment, Machine Type Communication (MTC) device, Device to Device (D2D) terminal, or any other nodes or devices in the wireless communication system 200, e.g. smart phone, laptop, mobile phone, sensor, relay, mobile tablets or even a small base station communicating within a cell.

Network nodes operate in the wireless communication system 200 such as a network node 210. The network node 210 may be any of RAN node, such as gNB, eNB, en-gNB, ng-eNB, gNB etc. The network node 210 provides radio coverage over a geographical area, a service area 11, which may also be referred to as a beam or a beam group where the group of beams is covering the service area of a radio access technology (RAT), such as 5G, LTE, NR or similar. The network node 210 may be a transmission and reception point e.g. a radio access network node such as a Wireless Local Area Network (WLAN) access point or an Access Point Station (AP STA), an access controller, a base station, e.g. a radio base station such as a NodeB, a gNodeB or gNB, an evolved Node B (eNB or eNodeB), a base transceiver station, a radio remote unit, an Access Point Base Station, a base station router, a transmission arrangement of a radio base station, a stand-alone access point or any other network unit capable of communicating with a wireless communication device within the service area served by the network node 210 depending e.g. on the radio access technology and terminology used.

To enhance the coverage or capacity of a network node, beamforming is employed at the network node towards one or multiple UEs. To suppress the leakage between a TX antenna panel and an RX antenna panel in full-duplex mode, beam-nulling is exploited at the TX antenna panel or RX antenna panel to set nulling point at the RX antenna panel or TX antenna panel, respectively. A split antenna panels for a network node with two antenna panels must be calibrated to acquire beamforming or beam-nulling gains. All of these functions require good antenna calibration. However, existing methods cannot achieve this requirement with reasonable low complexity.

As discussed in the background, the RX only panel may be calibrated by in-field AC. In-field AC relies on direction-of-arrival (DoA) estimation of over-the-air (OTA) channel-state information (CSI). In wireless communications, CSI refers to the channel properties of a communication link. This information describes how a signal propagates between a transmitter and a receiver. In-field AC extracts antenna impairments from the CSI of an end-to-end channel, i.e. the communication channel from a transmitter to a receiver or from a receiver to a transmitter, by removing the OTA CSI which is reconstructed from the DoA estimation. In another word, the accuracy of DoA estimation is crucial to the result of in-field AC. For example, in a coarse-calibrated radio antenna system, it may have a decent accuracy of DoA estimation. However, it may have problem in an uncalibrated antenna system because the initial DoA estimation is not feasible due to the potential up to +/−180 degree phase misalignment. Therefore, in-field AC can only be employed as an online verification to monitor the accuracy of calibrated antenna array or to improve calibration by estimating the residual calibration errors of a pre-calibrated antenna array, and it cannot be used to calibrate the fully uncalibrated RX antenna array.

In order to overcome the limitations of in-field AC, a method is provided that can calibrate the RX only panel with channel parameters provided from the already calibrated TX/RX panel.

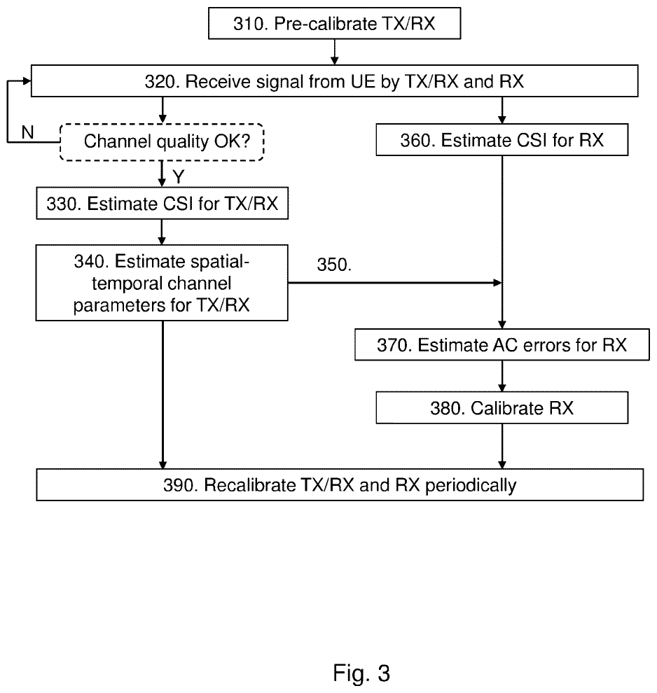

A method performed by a network node 210 in a wireless communication system 200 for antenna calibration will be described with reference to FIG. 3. The network node 210 comprises two or more antenna panels which are separated and isolated from each other. At least one antenna panel comprises both transmitting and receiving (TX/RX) antenna arrays, and at least one antenna panel comprises only receiving (RX) antenna array. The method comprises the following actions which may be performed in any suitable order.

### Action 310

The network node 210 is configured to perform initial calibration on the TX/RX antenna panel with both TX and RX antenna arrays. Although the TX/RX antenna panel has not been pre-calibrated, it is functioned with full TX and RX chains, therefore it can be calibrated by any known AC method, e.g. MC AC. After Action 310 completes, the TX/RX antenna panel is pre-calibrated so that it can be used to estimate channel-state information (CSI) for the TX/RX antenna arrays on a propagation channel between a user equipment and the TX/RX antenna arrays and extract spatial-temporal channel parameters of the propagation channel.

### Action 320

To estimate CSI for the TX/RX antenna arrays on a propagation channel between the user equipment and the TX/RX antenna arrays, the network node 210 is configured to receive a signal sent from a user equipment UE 230, i.e. an UL signal from UE 230. The signal sent from UE 230 may be a Sounding Reference Signal (SRS), a Physical Random Access Channel (PRACH) signal, a UE specific reference signal e.g. DeModulation Reference Signal (DMRS), or a UE's UL data signal. The signal is received via both the TX/RX antenna arrays and the RX antenna array.

If a narrow-band receiver is available in the radio unit of the network node 210, as disclosed in WO2021/223892, using this narrow-band receiver can be seen as a neat and low complex way of doing the initial calibration especially considering that the first SRS and PRACH signals are narrowband signals.

To have more accurate estimation of the CSI, a channel quality check may be performed. According to some embodiments herein, the network node 210 may be configured to estimate a channel quality based on the received signal from the UE 230 via the TX/RX antenna arrays. The channel quality may be determined by determining whether a signal-to-noise ratio or mean squared error (MSE) of the received signal is worse or better than a quality threshold. When the channel quality fulfils a first condition, i.e. is lower or worse than the quality threshold, the network node 210 is configured to receive a signal sent from another UE, e.g. UE 231, via TX/RX antenna arrays and then estimate a channel quality based on the received signal from this UE 231. When the channel quality of the received signal from this UE 231 fulfils a second condition, i.e. is higher or better than the quality threshold, the network node 210 is configured to perform the following actions.

### Action 330

The network node 210 is configured to estimate CSI for the TX/RX antenna arrays on the propagation channel between the user equipment and the TX/RX antenna arrays based on the received signal.

In addition to a normal channel estimation, a delay-angle channel model is exploited to extract spatial-temporal information from the CSI estimation. The spatial-temporal information is referred to spatial-temporal channel parameter and will be used to calibrate the RX antenna array. The spatial-temporal channel parameter may be any one of DoA, ToA, Doppler spread, delay spread, angular spread etc. As an example, extracting or estimating DoA will be described in the following.

The UL received signal vector at the TX/RX antenna arrays may be modelled as

$${r}_{k} = {ϕ}_{k} {\sum }_{p = 1}^{{N}_{p}} {A}_{p} exp ( j 2 π \frac{{λ}_{c}}{{λ}_{k}} d sin {θ}_{p} ) {t}_{k} + {n}_{k}$$

$${r}_{k} = {\underbrace{{ϕ}_{k} {H}_{k}}}_{{\tilde{H}}_{k}} {t}_{k} + {n}_{k}$$

Where Nₚ is the number of propagation channels or paths and p the index of a path, d is the receive antenna element vector for subcarrier k. λ_{c} and λₖ is the wavelength for the carrier and the sub-carrier respectively and calculated as

$${λ}_{c} = \frac{c}{{f}_{c}} , {λ}_{k} = \frac{c}{{f}_{k}} ,$$

where c is the speed of light.

Aₚ is the complex gain of the propagation path p. θₚ is the DoA of the received signal from UE via the propagation path p.

For sake of compactness, Line-of-sight (LOS) path is used as example, i.e. Nₚ=1. Note, it does not have to be a pure LOS, but only requires an incident plane wave that are significantly stronger than other waves incident at the same delay to avoid too much multi-path interference. Hence, delay information from the TX/RX panel could support filtering out relevant delays to suppress multipath interference further. For multipath communication, the approach disclosed in WO2020043310A1 may be exploited to mitigate unwanted NLOS paths and keep clean LOS path.

Hₖϵ [symbol] is a complex matrix representing the estimated CSI and is varying over subcarriers or frequencies k. Nᵣ and Nₜ are the number of receiving antenna elements and the number of transmitting antenna elements, respectively.

φₖϵ [symbol] is a complex diagonal matrix representing the phase and amplitude offsets introduced by the antenna system and are varying over subcarriers or frequencies k.

tₖϵ [symbol] is a complex vector representing the received signal from UE.

nₖ is unknown noise and distortion.

The TX/RX antenna arrays are pre-calibrated in Action 310 by transmitting and receiving known reference signals, i.e., a roundtrip measurement to derive the relative phase and gain relation in between antennas. After performing this existing antenna calibration method, it is assumed that φₖ=1, i.e. φₖ is an all-ones vector for the TX/RX antenna arrays.

For the RX only antenna array, φ̅ₖ represents the antenna calibration error, i.e. the antenna impairments that is unknown and to be estimated and calibrated by the proposed method herein.

Noteworthily, the CSI matrix Hₖ is different for the TX/RX panel and RX only panel. For this reason, Hₖ is denoted as the channel for the TX/RX panel, and H̅ₖ is denoted as the channel for the RX only panel. Accordingly, one denotes Ĥₖ as the CSI estimation of the TX/RX panel, and \hat{H̅}ₖ as the CSI estimation of the RX only panel. These denotations will be used hereafter.

### Action 340

The network node 210 is configured to estimate one or more spatial-temporal channel parameters based on the estimated CSI, Ĥₖ, for the TX/RX antenna arrays. Due to the small-scale fading, the estimated CSI, \hat{H̅}ₖ, for the RX only antenna arrays are different to the Ĥₖ, for the TX/RX antenna arrays.

According to some embodiments herein, the network node 210 may be configured to calculate a relative phase average based on the estimated CSI for the received signal via the TX/RX antenna arrays. From the relative phase average, a set of steering vectors may be found making the two relative phase errors of the TX/RX arrays and RX array similar e.g. using MSE. A covariance matrix of the the estimated CSI for the received signal via the TX/RX antenna arrays consists of the relative phase average difference between the antenna elements in the TX/RX antenna arrays. So the network node 210 may be configured to calculate a covariance matrix of the the estimated CSI for the received signal via the TX/RX antenna arrays, expressed by an equation:

$${\hat{R}}_{TX / RX} = \frac{1}{{N}_{{SC}_{NB}}} {\sum }_{k ∀ {SC}_{NB}} {\hat{H}}_{k} {\hat{H}}_{k}^{H}$$

Where, N_{SC}_{_{NB}} represents the number of OFDM subcarriers that the signal is received on. However, N_{SC}_{_{NB}} may be any set of signals improving the estimate of phase average over a number of elements e.g., the number of time instances that the signal is received on, or the number of different types of UL signals etc.

The network node 210 is configured to establish a set of steering vectors from the covariance matrix. The spatial characteristics of the covariance matrix is visible in the set of steering vectors. Suppose that a(θₚ) is the general steering vector for any distribution of antenna elements corresponding to angle θₚ, for a uniform linear array (ULA), a(θₚ) can be given by

$$a ( {θ}_{p} ) = {[ 1 exp ( j 2 π \frac{{λ}_{c}}{{λ}_{k}} sin {θ}_{p} ) exp ( j 2 π \frac{{λ}_{c}}{{λ}_{k}} 2 sin {θ}_{p} ) … exp ( j 2 π \frac{{λ}_{c}}{{λ}_{k}} ( {N}_{r} - 1 ) {θ}_{p} ) ]}^{T}$$

The network node 210 is further configured to obtain the one or more spatial-temporal channel parameters from the set of steering vectors. For sake of compactness, the steering vector a(θₚ) is given by example based on ULA. It can be extended to other array geometries with different steering vectors.

The estimation of the one or more spatial-temporal channel parameters may be performed by searching the θₚ, whose steering vector a(θₚ) has the maximum correlation with the covariance matrix \hat{R}_{TX/RX}, which may be expressed as

$${\hat{θ}}_{p} = {arg max}_{θ} {‖ a ( θ ) {\hat{R}}_{TX / RX} {a}^{H} ( θ ) ‖}^{2}$$

That is, the network node 210 is configured to obtain the one or more spatial-temporal channel parameters from the set of steering vectors by searching the maximum correlation between the set of steering vectors and the covariance matrix, i.e. searching a spatial-temporal channel parameter whose steering vector has the maximum correlation with the covariance matrix.

To have better accuracy, an example is to use the minimum variance distortion less response (MVDR), which is expressed as

$${\hat{θ}}_{p} = {arg max}_{θ} \frac{1}{{‖ a ( θ ) {\hat{R}}_{TX / RX}^{- 1} {a}^{H} ( θ ) ‖}^{2}}$$

Some other methods may also be used to estimate the one or more spatial-temporal channel parameters from the set of steering vectors. For examples, sub-space methods such as singular value decomposition (SVD), Estimation of Signal Parameters via Rotational Invariance Technique (ESPRIT), MUltiple Signal Classificatio (MUSIC), etc. may be used.

Note that the covariance matrix \hat{R}_{TX/RX} of the CSI for the TX/RX antenna arrays does not contain φₖ, therefore it can be used for estimating the DoA of the received signal from UE. Meanwhile, the covariance matrix \hat{R}_{RX} of the CSI for the RX antenna array contains φ̅ₖ, the DoA of the received signal from UE cannot be obtained by the covariance matrix \hat{R}_{RX}. However, the distance between two panels is much smaller than the distance between the UE and network node 210, the plane wave assumption is still right. Due to that, the DoA of the received signal from the UE can be shared between two antenna panels. Once \hat{θ}ₚ is obtained, it can be used for RX antenna panel to compensate the impact of the propagation channel. It is noted that \hat{θ}ₚ is common for TX/RX panel and RX only panel.

### Action 350

The network node 210 is configured to provide the one or more spatial-temporal channel parameters estimated for the TX/RX panel to the RX only panel. The one or more spatial-temporal channel parameters may be DoA, ToA, or other additional information such as Doppler spread, delay spread, or angular spread, etc. Thanks to the information provided from the TX/RX panel to the RX only panel, the channel estimation can be exploited for antenna calibration for the RX only panel.

### Action 360

For the RX only panel, it is assumed that no prior calibration function is employed, hence φ̅ₖ≠1, and which needs to be estimated and calibrated.

To estimate φ̅ₖ of the RX antenna array, the network node 210 is configured to estimate CSI for the RX antenna array on a propagation channel between the user equipment and RX antenna array based on the received signal. The RX antenna array receives the UL signal from the UE and performs the channel estimation. It is noted that the RX antenna array hasn't been calibrated, therefore it cannot extract the spatial-temporal information from the estimated CSI matrix \hat{H̅}ₖ.

For the RX only panel the covariance matrix \hat{R}_{RX} of the CSI matrix \hat{H̅}ₖ is written as

$${\hat{R}}_{R X} = \frac{1}{{N}_{{SC}_{N B}}} {\sum }_{k ∀ S {C}_{N B}} {\hat{\overline{H}}}_{k} {\hat{\overline{H}}}_{k}^{H}$$

Based on \hat{R}_{RX}, \dot{φ}ₖ will be estimated. The optimal estimation of φ̅ₖ may be obtained by extensive searching to maximize the correlation, which can be expressed as

$$\hat{\overline{ϕ}} = {arg max}_{ϕ} {\vert \overline{a} ( {\hat{θ}}_{p} ) ϕ {\hat{R}}_{R X} {ϕ}^{H} {\overline{a}}^{H} ( {\hat{θ}}_{p} ) \vert}^{2}$$

Where

$$\hat{\overline{ϕ}} = diag ( {e}^{j {\hat{\overline{ϕ}}}_{1}} , … , {e}^{j {\hat{\overline{ϕ}}}_{{N}_{r}}} ) .$$

ā(θₚ) is the set of the steering vectors for RX only antenna array with respect to the estimated channel parameter \hat{θ}ₚ, i.e. the DoA, derived for the TX/RX antenna arrays in Action 340 described above. It is worth mentioning that the geometries of TX/RX antenna array and RX only antenna array are not necessarily the same.

Note, one could do the same for each sub-carrier or a subset of subcarriers if the φ̅ₖ is frequency dependent.

Therefore, according to some embodiments herein, the antenna calibration errors of the RX antenna array, i.e. the amplitude and phase error, may be obtained by correlating a set of antenna calibration errors with the covariance matrix of the CSI for the RX antenna array that has the maximum value on the directions defined by the set of steering vectors with corresponding spatial-temporal channel parameters for the TX/RX antenna array.

However, this estimation has prohibitive complexity because the searching space of φ̅ is too large to be accomplished. To ease the realization, one can simplify the operation as follows.

### Action 370

The network node 210 is configured to estimate antenna calibration errors for the RX antenna array based on the estimated CSI for RX antenna array and the one or more estimated spatial-temporal channel parameters for the TX/RX antenna arrays.

Although the spatial-temporal information cannot be extracted from the CSI of the RX antenna array, the relevant information can be obtained from the TX/RX panel. When the RX only panel receives the relevant channel parameters from the TX/RX panel, the antenna error can be extracted from the channel estimation by removing the impacts from the propagation channel.

The CSI of RX antenna array \hat{H̅}ₖ may be modified by the ā(\hat{θ}ₚ) as

$${\hat{\tilde{\overline{H}}}}_{k} = \overline{a} ( {\hat{θ}}_{p} ) ⊙ {\hat{\overline{H}}}_{k}$$

Where ⊚ denotes the element-wise multiplication.

This is to rotate the CSI matrix \hat{H̅}ₖ by the spatial-temporal channel parameters to have an LOS component as a plane wave in boresight direction. This way, the received signal from the UE looks like originating from a boresight LOS channel. That means, as a result of this “rotation”, the impacts from the propagation channel is removed, NLOS components are reduced, the LOS component shall show up as a plane wave in boresight direction and all deviations from this will be seen as antenna calibration errors. This is an approximation since propagation channel has multiple of paths. Approximation is good enough for the antenna calibration in this step. Further enhancements with possibilities to clean out multipaths may be implemented. For multipath channel with lots of NLOS paths, i.e. Nₚ>1, NLOS mitigation proposed in WO2020043310A1 may be exploited to remove data contribution from unwanted NLOS paths. After that, a clean LOS path can still be retained, and the LOS path is directed from the boresight. If the channel doesn't contain the LOS path, the strongest NLOS path can also be used.

After modification of \hat{H̅}ₖ, the modified covariance matrix is given by

$${\hat{\tilde{R}}}_{RX} = \frac{1}{{N}_{{SC}_{N B}}} {\sum }_{k ∀ {SC}_{NB}} {\hat{\tilde{\overline{H}}}}_{k} {\hat{\tilde{\overline{H}}}}_{k}^{H}$$

Meanwhile, the covariance matrix can be written as,

$${\hat{\tilde{R}}}_{RX} = [ \begin{matrix}{R}_{11} & {R}_{12} & {R}_{13} & … & {R}_{1 {N}_{r}} \\ {R}_{12}^{*} & {R}_{22} & {R}_{23} & … & {R}_{2 {N}_{r}} \\ {R}_{13}^{*} & {R}_{23}^{*} & {R}_{33} & ⋯ & {R}_{3 {N}_{r}} \\ ⋮ & ⋮ & … & ⋱ & ⋮ \\ {R}_{1 {N}_{r}}^{*} & {R}_{2 {N}_{r}}^{*} & {R}_{3 {N}_{r}}^{*} & … & {R}_{{N}_{r} {N}_{r}}\end{matrix} ]$$

Since the impact of wireless propagation channel has been removed, the antenna calibration error, i.e. phase and amplitude error of antenna r, r=1, . . . Nᵣ, can be computed by

$${\hat{\overline{Φ}}}_{r} = ∠ ( \frac{{R}_{1 r}}{\frac{1}{{N}_{r}} {\sum }_{i} {R}_{1 i}} )$$

∠(x) represents angle of the variable (x).

To this end, the amplitude and phase error φ̅ of the RX antenna array is obtained. The compensation of this error can be done by applying the inverse of this value on the received signal via the RX antenna array in digital receiver processing chain at baseband.

Therefore, according to some embodiments herein, The network node 210 may be configured to estimate antenna calibration errors for the RX antenna array by being configured to calculate a modified CSI for RX antenna array based on the one or more estimated spatial-temporal channel parameters from the TX/RX antenna arrays by multiplying element-wise the steering vector with a corresponding spatial-temporal channel parameter for the TX/RX antenna arrays with the estimated CSI for RX antenna array, calculate a covariance matrix of the modified CSI for RX antenna array and calculate the antenna calibration errors based on the covariance matrix of the modified CSI for RX antenna array by dividing the values in one row or column of the covariance matrix of the modified CSI with an average value of all values in that row or column of the covariance matrix of the modified CSI.

### Action 380

The network node 210 is configured to calibrate the RX antenna array based on the estimated antenna calibration errors. That is, the phase and/or amplitude of a received signal via the RX antenna array is compensated in digital receiver processing chain based on the estimated antenna calibration errors. After this action completes, the RX only panel is initially calibrated.

### Action 390

Due to the phase drifting of an antenna array, the antenna calibration may be performed periodically to compensate the phase drifting. This periodical calibration may be accomplished by recalibrate the TX/RX antenna arrays and RX antenna array as described in Action 310 and Actions 320-380.

Although the proposed method is described with an example of a uniform linear array (ULA), it can be applied to an antenna array with any geometry form. Furthermore, there is no such limitation that TX/RX panel and RX only panel must have the same geometry.

The covariance matrix is estimated by the number of the subcarriers N_{SC}_{_{NB}}. Here, N_{SC}_{_{NB}} may be small if the channel appears a strong frequency selectivity, or N_{SC}_{_{NB}} may be large e.g. equals to the whole number of subcarriers if the channel appears a weak or flat frequency selectivity. Therefore, the number of subcarriers N_{SC}_{_{NB}} may be selected according to the frequency selectivity of channel. That means \hat{R}_{TX/RX} and \hat{R}_{RX} collapse over subcarriers hence they have limited frequency knowledge if used as they are. Therefore, using this narrowband covariance as the basis for estimating φ̅ₖ depends on its dependency to k and the bandwidth, i.e. the number of subcarriers k, used.

Without system limitation, the method according to embodiment herein can estimate the covariance on the number of sub-carriers from one sub-carrier to all sub-carriers depending on the channel characteristics.

If a narrow-band receiver with limited bandwidth is available in the network node 210, the method according to embodiment herein can use the narrow-band receiver (NBR) antenna with a reduced set of antenna elements to receive a full bandwidth signal.

The method according to embodiment herein use the covariance matrix \hat{R}_{TX/RX} to estimated main directions of arrival θₚ. There will be interference from other propagation paths, but the interference can be suppressed enough by the beamforming gain. The interference can also be suppressed in the delay domain by removing non-relevant delay taps belonging to other propagation paths. In the delay domain, a multipath fading channel can be seen as a finite impulse response filter with many filter taps, where one tap denotes one resolvable path.

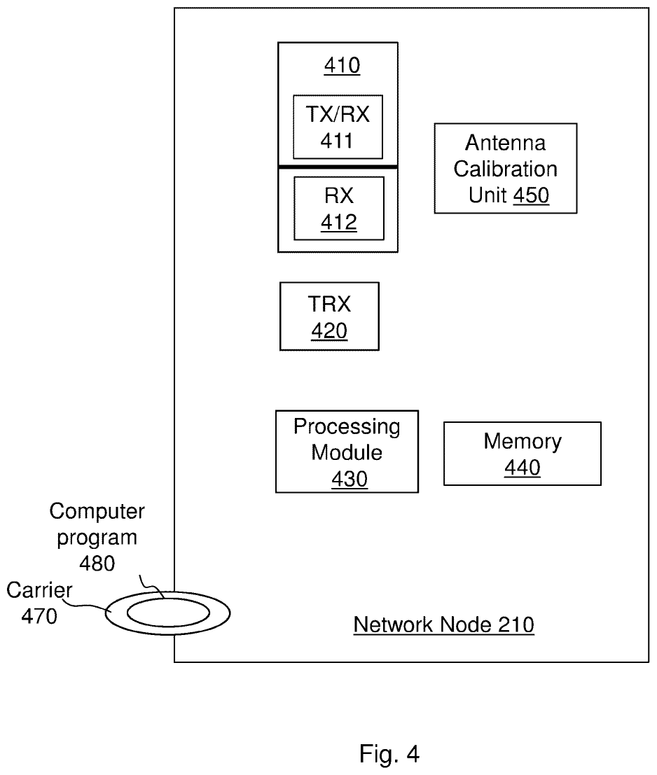

FIG. 4 shows an example of a network node 210 in which the method for antenna calibration may be implemented. The network node 210 may be a base station, for example, an eNB, gNB, eNodeB, gNodeB. The network node 210 may comprise an antenna unit 410 comprising a TX/RX antenna panel 411 and a RX panel 412, one or more transceiver TRX 420 for receiving and transmitting signals, a processing module 430 for processing signals, and a memory 440 for storage data, instructions, configurations etc. The network node 210 may further comprise an antenna calibration unit 450 for antenna calibration. The method for antenna calibration may be implemented in the antenna calibration unit 450 or in the processing module 430. The method for antenna calibration may also be implemented through one or more processors in the network node 210 together with computer program code for performing the functions and actions of the embodiments herein. The program code mentioned above may also be provided as a computer program product, for instance in the form of computer readable medium or a data carrier 470 carrying computer program code or instructions 480, as shown in FIG. 4, for performing the embodiments herein when being loaded into the network node 210. One such carrier may be in the form of a CD ROM disc. It is however feasible with other data carriers such as a memory stick. The computer program code may furthermore be provided as pure program code on a server or a cloud and downloaded to the network node 210.

The network node 210 is configured to perform any of the method Actions 310-390 described above.

For example, the network node 210 is configured to, by means of e.g. the transceiver TRX 420 being configured to, receive a signal sent from a user equipment via both the TX/RX antenna arrays and RX antenna array.

The network node 210 is further configured to, by means of e.g. the processing module 430 or antenna calibration unit 450 being configured to, estimate channel-state information (CSI) for the TX/RX antenna arrays on a propagation channel between the user equipment and the TX/RX antenna arrays based on the received signal.

The network node 210 is further configured to, by means of e.g. the processing module 430 or antenna calibration unit 450 being configured to, estimate one or more spatial-temporal channel parameters based on the estimated CSI for the TX/RX antenna arrays.

The network node 210 is further configured to, by means of e.g. the processing module 430 or antenna calibration unit 450 being configured to, estimate CSI for the RX antenna array on a propagation channel between the user equipment and the RX antenna array based on the received signal;

The network node 210 is further configured to, by means of e.g. the processing module 430 or antenna calibration unit 450 being configured to, estimate antenna calibration errors for the RX antenna array based on the estimated CSI for the RX antenna array and the one or more estimated spatial-temporal channel parameters for the TX/RX antenna arrays; and

The network node 210 is further configured to, by means of e.g. the processing module 430 or antenna calibration unit 450 being configured to, calibrate the RX antenna array based on the estimated antenna calibration errors.

According to some embodiments herein, the method for antenna calibration may be implemented in a computer program product 470. The computer program product 470 comprises program code 480 which when the program is executed by a computer, cause the computer to carry out the method for antenna calibration as described above.

To summarize, some advantages of embodiments herein for antenna calibration are but not limited to:

Embodiments herein provide a cost-efficient solution to calibrate a split antenna array for a network node deployed with TX/RX antennal panel and RX only antenna panel with high isolation between the TX/RX and RX antenna panels, thereby enabling beamforming in a full-duplex radio unit. No extra coupler network or other calibration-specific hardware is needed for calibration of the RX only antenna panel. As a result, the size and weight of the full-duplex radio unit is reduced.

Embodiments herein are applicable to a totally uncalibrated antenna array. No need for pre-calibration for a RX only antenna array.

Embodiments herein are applicable to applications such as UL sensitivity boost, Joint communication and sensing (JCAS) or pulsed radar, full duplex, such as in-band full duplex and sub-band full duplex radio units and provide some benefits to these applications.

The calibration on the TX/RX and RX antenna panels may be performed periodically to track phase drifts over the time.

The word “comprise” or “comprising”, when used herein, shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1. A method performed by a network node for antenna calibration in a wireless communication system, wherein the network node comprises two or more antenna panels which are separated and isolated from each other, and wherein at least one antenna panel comprises both transmitting and receiving, TX/RX, antenna array, and at least one antenna panel comprises only receiving, RX, antenna array, wherein the TX/RX antenna arrays are pre-calibrated, the method comprising:
receiving a signal sent from a user equipment via both the TX/RX antenna arrays and RX antenna array;
estimating channel-state information, CSI, for the TX/RX antenna arrays on a propagation channel between the user equipment and the TX/RX antenna arrays based on the received signal;
estimating one or more spatial-temporal channel parameters based on the estimated CSI for the TX/RX antenna arrays;
estimating CSI for the RX antenna array on a propagation channel between the user equipment and the RX antenna array based on the received signal;
estimating antenna calibration errors for the RX antenna array based on the estimated CSI for the RX antenna array and the one or more estimated spatial-temporal channel parameters for the TX/RX antenna arrays; and
calibrating the RX antenna array based on the estimated antenna calibration errors.

2. The method according to claim 1, wherein estimating one or more spatial-temporal channel parameters based on the estimated CSI for the TX/RX antenna arrays comprises:
calculating a covariance matrix of the estimated CSI for the received signal via the TX/RX antenna arrays;
establishing a set of steering vectors from the covariance matrix; and
obtaining the one or more spatial-temporal channel parameters from the set of steering vectors.

3. The method according to claim 2, wherein obtaining the one or more spatial-temporal channel parameters from the set of steering vectors comprises searching of the maximum correlation between the set of steering vectors and the covariance matrix.

4. The method according to claim 1, wherein estimating antenna calibration errors for the RX antenna array based on the estimated CSI for RX antenna array and the one or more estimated spatial-temporal channel parameters for the TX/RX antenna arrays comprises:
calculating a modified CSI for RX antenna array based on the one or more estimated spatial-temporal channel parameters from the TX/RX antenna arrays;
calculating a covariance matrix of the modified CSI for RX antenna array;
calculating the antenna calibration errors based on the covariance matrix of the modified CSI for RX antenna array.

5. The method according to claim 4, wherein calculating a modified CSI for RX antenna array based on the one or more estimated spatial-temporal channel parameters for the TX/RX antenna arrays is performed by multiplying element-wise the steering vector with a corresponding spatial-temporal channel parameter for the TX/RX antenna arrays with the estimated CSI for RX antenna array.

6. The method according to claim 4, wherein calculating the antenna calibration errors based on the covariance matrix of the modified CSI for RX antenna array is performed by dividing the values in one row or column of the covariance matrix of the modified CSI with an average value of all values in that row or column of the covariance matrix of the modified CSI.

7. The method according to claim 1, wherein estimating antenna calibration errors for the RX antenna array based on the estimated CSI for RX antenna array and the one or more estimated spatial-temporal channel parameters for the TX/RX antenna arrays comprises:
calculating a covariance matrix of the CSI for the received signal via RX antenna array;
obtaining the antenna calibration errors by correlating a set of antenna calibration errors with the covariance matrix of the CSI for the RX antenna array that has the maximum value on the directions defined by the set of steering vectors with corresponding spatial-temporal channel parameters for the TX/RX antenna arrays.

8. The method according to claim 1, wherein the one or more spatial-temporal channel parameters comprises any one or more of direction-of-arrival, DoA, time-of-arrival, ToA, Doppler spread, delay spread, angular spread.

9. The method according to claim 1, wherein calibrating the RX antenna array comprises compensating phase and/or amplitude of the RX antenna array based on the estimated antenna calibration errors.

10. The method according to claim 9, wherein compensating phase and/or amplitude of the RX antenna array based on the estimated antenna calibration errors comprises compensating the phase and/or amplitude of a received signal in digital receiver processing chain based on the estimated antenna calibration errors.

11. The method according to claim 1, wherein the TX/RX antenna arrays are pre-calibrated by mutual coupling, MC, based antenna calibration.

12. The method according to claim 1, further comprising calibrating periodically the TX/RX antenna arrays using MC based antenna calibration and the RX antenna array.

13. The method according to claim 1, further comprising:
estimating a channel quality of the received signal from the UE via the TX/RX antenna arrays;
when the channel quality is lower than a threshold,
receiving a signal sent from another UE via the TX/RX antenna arrays;
estimating a channel quality of the received signal from this UE;
when the channel quality is higher than the threshold,
performing the estimating steps and the calibrating step of claim 1.

14. The method according to claim 13, wherein estimating a channel quality comprises determining whether a signal-to-noise ratio or mean squared error of the received signal is larger or smaller than the threshold.

15. A network node configured to perform the method for antenna calibration according to claim 1.

16. A computer program product comprising program code which when the program is executed by a computer, cause the computer to carry out the method for antenna calibration according to claim 1.
